(19) United States
(12) Patent Application Publication
(10) Pub. No.: US 2011/0067637 A1
(43) Pub. Date: Mar. 24, 2011

(54) Squirrel guard for a bird feeder

(76) Inventor: D. Calvin Baynard, Manning, SC (US)

(21) Appl. No.: 12/586,487

(22) Filed: Sep. 23, 2009

(51) Int. Cl. A01K 39/01

(52) U.S. Cl. 119/57.9

(57) ABSTRACT

A squirrel guard for use with bird feeder which stores and dispenses bird seed. The feeder comprises an upstanding housing formed along a vertical axis including side walls, a roof and a floor adjacent its lower side. A support is provided for positioning the feeder in an elevated position. The squirrel guard comprises a generally round and planar tray having a circular opening about its axis which is mounted beneath the lower side of the feeder. The tray acts to deny squirrel access to the bird seeds and also as a collection tray for spilled bird seed. A connector is arranged beneath the lower side for supporting the tray in a generally horizontal position when carrying only a minimal weight such as bird seed and small birds. The connector is such that the tray tilts to a generally diagonal position when engaged with a relatively heavy weight such as a squirrel. When tilted, the tray normally remains in the horizontal position collecting spilled bird seed but moves to the tilted position when engaged by a squirrel causing the squirrel to fall from the tray.

### BACKGROUND OF THE INVENTION

This invention is directed to a squirrel guard in combination with a bird feeder. As is well-known, bird feeders store and dispense bird seed for birds. A problem with most bird feeders is encroachment by small animals, especially squirrels.

There have been numerous attempts to build bird feeders to include apparatus to prevent access to the seed by these animals, especially squirrels.

Attempts to provide squirrel guards are shown in applicant's U.S. Pat. Nos. 7,373,901 B2 and 7,409,992 B1

It was found that squirrels could bypass these guards because they were mounted in stable positions.

Accordingly, it is a primary object of the instant invention to provide a collection tray for collecting spilled seed which also functions as a squirrel guard which blocks squirrel access to the bird feeder.

Another object of the invention is the provision of a squirrel guard movable between a horizontal collection position and a diagonal or tilted discharge position in dependence upon the weight applied to its upper surface.

Another object of the invention is the provision of various mounting structures which will accommodate such a squirrel guard between these positions and yet support it in position relative to the feeder.

### SUMMARY OF THE INVENTION

The instant invention is directed to a squirrel guard for use with a bird feeder. The bird feeder acts to store and dispense the feed comprising an upstanding housing formed along a vertical axis and includes side walls, a roof and a floor adjacent to its lower side. A support is provided for positioning the feeder in an elevated position. The squirrel guard comprises a generally round and planar tray, with a circular opening about its central axis and is mounted beneath the lower side. The tray acts to prevent squirrel access to the bird seeds and as a collection tray for spilled bird seed.

A connector is arranged beneath the lower side and is engaged with and supports the tray in a generally horizontal position perpendicular to the vertical axis when only a minimal weight, such as bird seed and small birds, is carried by said tray and allowing the tray to tilt relative to the vertical axis to a generally diagonal discharge position when it is engaged with a relatively heavy weight, such as a squirrel. Therefore, in use, the tray normally remains in the horizontal position collecting spilled bird seed but moves to the discharge position when engaged by a squirrel causing the squirrel to fall from the tray.

The connector may comprise a rod located beneath the lower side and extending downwardly through the opening. A flat washer, which supports a cone-shaped washer, is secured with the rod in spaced position beneath the lower side. The flat washer supports the tray in the generally horizontal position while the cone-shaped washer maintains the tray centered about the vertical axis, allowing the tray to pivot to the discharge position when the tray is engaged by a squirrel and guides the tray back to the horizontal position upon departure of the squirrel.

An extension may be engaged with the upper end of the rod and the lower side of the feeder. The extension acts to support the feeder in an elevated position and to position the feeder in fixed position relative to the upper end of the rod.

The connector may comprise a plurality of flexible extensions extending parallel of the vertical axis and perpendicular of the lower side and the tray. The extensions are engaged with the tray generally adjacent and about the circular opening and with the feeder.

The extensions may be engaged with a ring located beneath the lower portion of the feeder. There may be a circular guard positioned about the flexible extensions and restriction on the tray.

The connector may comprise a rod pivotally secured with at least one of the lower side and the tray along the vertical axis. The pivotal engagement allows the tray to move between the discharge position and the horizontal position.

The connector may comprise a rod fixed at one end with the lower side along the vertical axis. The opposite end of the rod carries a flat washer supporting on its upper side a cone-shaped washer. The tray is supported and positioned by the flat washer and the cone-shaped washer.

The connector may comprise a pole extending vertically from the ground and having at its upper end an extension passing through the circular opening. The extension carries a flat washer and a cone-shaped washer. The cone-shaped washer extends through the circular opening allowing the tray to be separated on the flat washer centrally of the axis of the pole. A C-shaped rod, which engages at one end with the extension and at an opposite end with the roof, holds the feeder in position above the tray.

The tray opening is about 1 3/16″ in diameter; the diameter of the flat washer is 1¾″; and, the diameter of the cone-shaped washer is 1 5/16″.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a perspective view of a bird feeder and a squirrel guard in accordance with the instant invention;

FIG. 2 is a sectional plane view of the feeder openings;

FIG. 3 is a sectional side view of the pole connection and support for the flat and oval washers along with the tray;

FIG. 4 is a cutaway sectional view of the interconnected pole supporting the tray in a diagonal position;

FIG. 5 is a perspective view of the same tray support with a C-shaped feeder support;

FIG. 6 is a perspective view of a chain and hook tray support;

FIG. 7 is a side view of the hook and tray support;

FIG. 8 is a perspective view of another tray supporting arrangement;

FIG. 9 is similar to FIG. 8 showing the cover cam in broken lines;

FIG. 10 is similar to FIG. 9 showing the tray in its diagonal position.

### DESCRIPTION OF A PREFERRED EMBODIMENT

Referring now in more detail to the drawings, the invention will now be described in more detail.

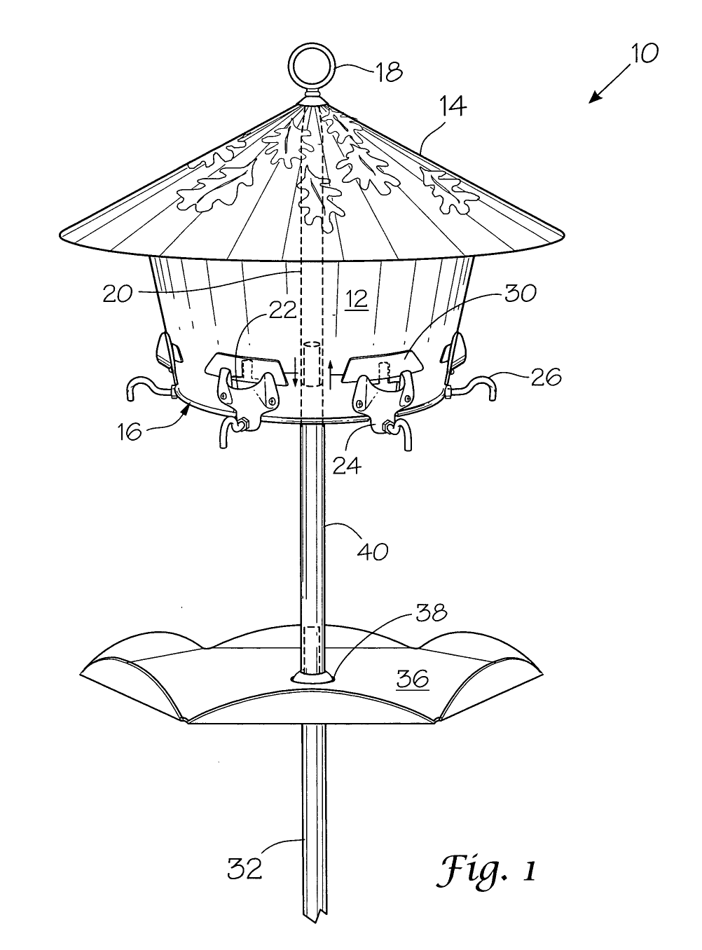

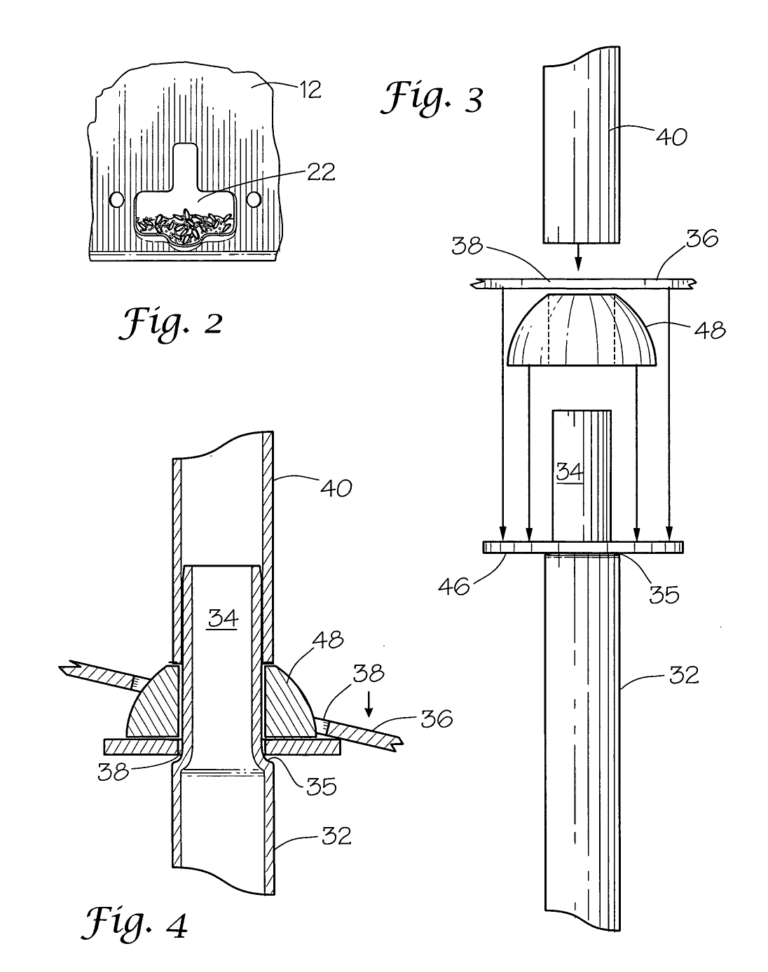

A typical bird feeder, according to the invention, is shown in FIG. 1. Feeder 10 is preferably made of metal and consists of a circular housing 12 having a vertical wall, a roof 14, a lower side 16, including a floor. Various arrangements, including a ring 18 attached with roof 14 or a receptor or connector 20 associated with the floor and lower side 16, may be employed to assist in supporting feeder 10 in an elevated position.

Arranged about the housing of feeder 10 are openings 22 which are in the general shape of an inverted T. A collar 24 is positioned adjacent and below each opening forming a feed channel. A perch 26 extends outwardly from the feed channel in known manner. The outer edges of collar 24 forming the feeder also function to receive the outer ends of door 30. Door 30 is adjustable vertically to adjust the size of opening 22 which controls the delivery of the bird seed to the feeder 22. Perches 26 may also be adjusted longitudinally.

The squirrel guard comprises a planar tray 36 having a circular opening 38 formed about its center axis. The size of the opening may vary as desired. The outer edge of tray 36 may be circular or may include a plurality of upturned edges as desired. The inner edges of the opening may be reinforced or they may contain a plurality of openings 54 as shown in FIG. 9. The planar upper surface is desired when the tray is intended for its primary function, i.e., use as a squirrel guard. The upper surface, having upturned edges, is desired when the tray functions primarily as a seed saver.

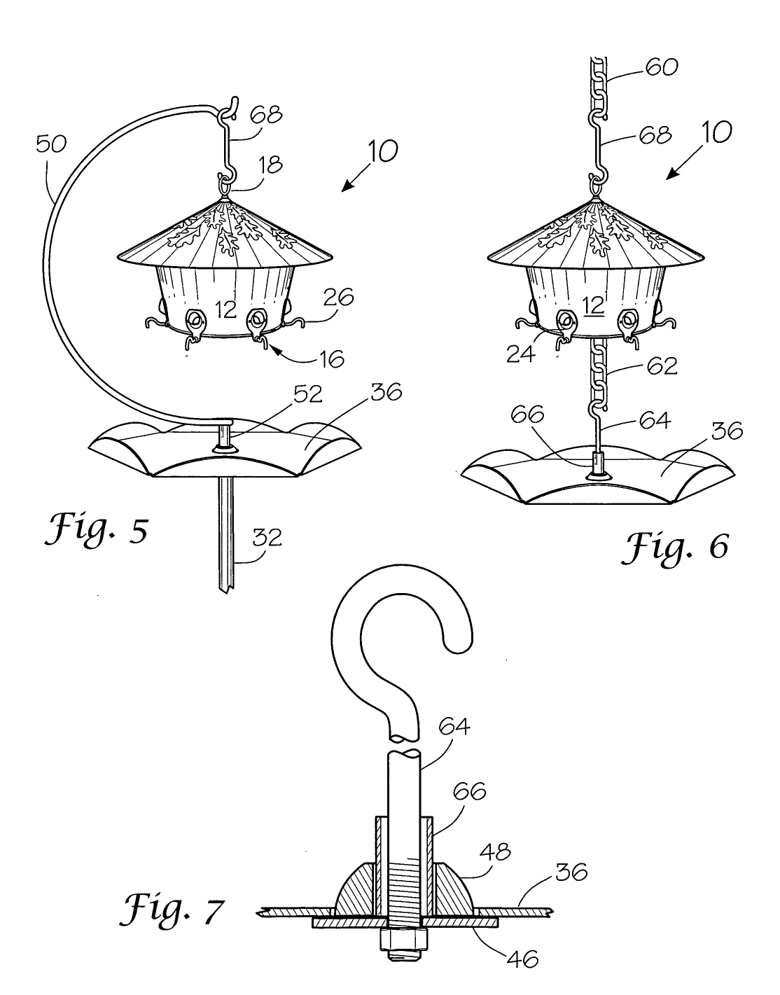

Numerous mechanisms may be employed to position the feeder in an elevated position. A first of these may include a flexible member, such as C-shaped rod 50 or chain 60, engaged with ring 18 as shown in FIGS. 5 and 6. Another and more usual mechanism would include pole 32 secured in the ground to extend vertically with feeder 10 supported at its lower side 16 by the upper end of the pole as shown in FIG. 1.

A first of several arrangements of the latter mounting arrangement is shown in FIGS. 1, 3 and 4. Here pole 32 is shown in the vertical position. Formed on its upper end is extension 34 which is of less diameter than the pole and forms a shoulder 35 with the pole where they intersect.

This arrangement may be expanded to include a second pole extension pole 40 of selected length secured over extension 34 and engaging with the lower side 16 of feeder 10, in known manner, supporting the feeder in a fixed vertical position.

Tray 36 is positioned with pole 32 extending through opening 38 and preferably with its planar surface on the upper side, as shown in FIG. 9.

It is desirable that tray 36 be located about 12″ below lower side 16 of feeder 10 to allow sufficient space for birds to feed and space for the tray to tilt to a diagonal or discharge position. Also, this distance requires a squirrel to climb the pole or other support in order to reach the feeder.

A first arrangement for mounting tray 36 beneath feeder 10 comprises positioning a flat washer 46 over extension 34 to rest on shoulder 35 and a cone-shaped washer 48 over extension 34 to rest on the flat washer. Flat washer 46 has a diameter greater than the diameter of circular opening 38 while cone-shaped washer 48 has a maximum diameter slightly less than that of opening 38. Preferably, the diameter of the cone-shaped washer is 1 5/16″ and flat washer is 1¾″.

Tray 36 is supported in its elevated horizontal position by flat washer 46 and shown in FIG. 1. Cone-shaped washer 48, as seen in FIGS. 1 and 4, acts to keep tray 36 centered along the vertical axis by passing through opening 38 when the tray is in its horizontal position but allows tray 36 to tilt to a diagonal or discharge position when engaged by a heavy object such as a squirrel, as seen in FIG. 4.

This arrangement may be slightly altered when supporting tray 36, as shown in FIG. 6. A pole and/or chain 62 is secured with underside 16 of the feeder and may include a hook extension 64 on its lower end. Flat and cone-shaped washers 46, 48 may be secured with the lower end of hook extension 64 to support tray 36 in the manner as above described. A collar 66 may be provided to center cone-shaped washer 48. See FIG. 7.

Another arrangement, as shown in FIGS. 3 & 4, would be to position the flat and cone-shaped washers 46, 48 to rest on shoulder 35 of pole 32, as above described, to position tray 36 on the washers as described.

C-shaped rod 50 having a connector 52 arranged at one end is provided. Connector 52 is engaged over extension 34 of pole 32 as shown in FIGS. 4 and 5, to position the C-shaped rod in a generally vertical position. Feeder 10 is supported by ring 18 which is engaged within the C-shaped rod with its lower end spaced above tray 36 by about 15″. A connector 68, comprising a rod with opposed hooks, may or may not be provided.

Another embodiment is to provide additional openings 54, preferably three, about opening 38. Providing a plurality of flexible extensions 44 and securing lower ends with the additional openings 54 and securing the upper ends of flexible extensions 44 with lower side of feeder 10 or with a ring 42 as shown in FIG. 9. Tray 36 extends downwardly generally perpendicular with the vertical axis of pole 22. The flexible extensions 44 support tray 36 at a desired distance from lower side 16 in a generally horizontal position. The application of weight to one edge causes the tray to tilt to a generally diagonal position.

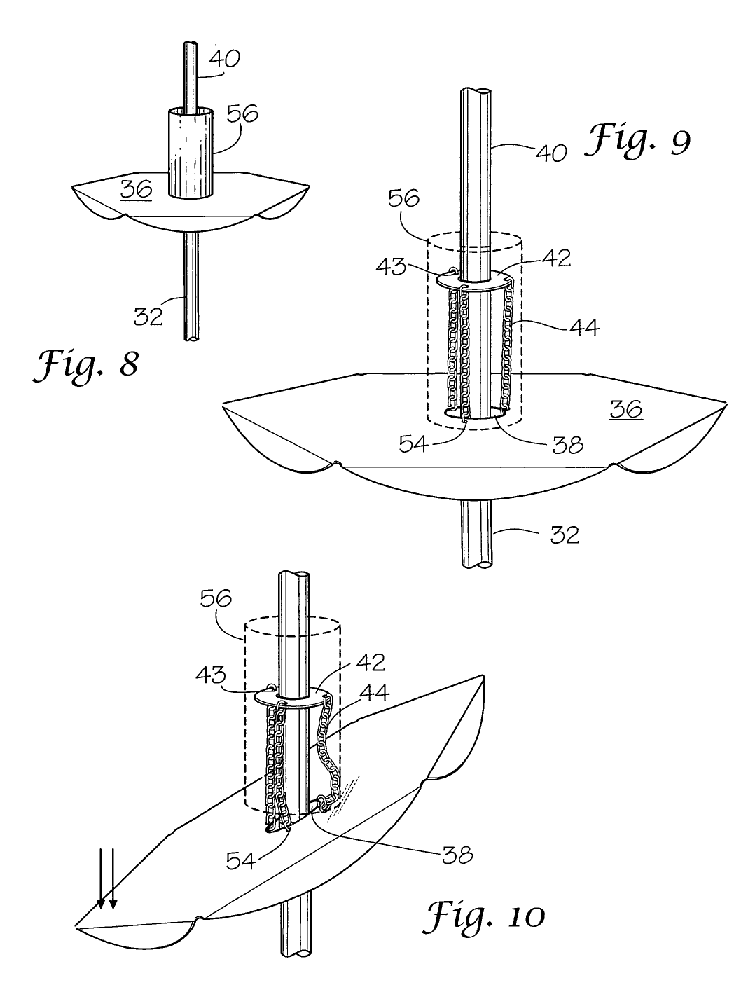

Another arrangement would be to have a ring 42 position over extension 34 to rest on shoulder 35. Providing ring 42 with openings 43 to receive the upper ends of flexible extensions 44. Tray 36, through openings 54, is connected with lower ends of flexible extensions 44. The feeder in both arrangements may be supported in an elevated position from either its roof 14 or its lower side 16 using these alternative arrangements. See FIGS. 8-10. It is desired to limit the flexible extensions to three.

When employing flexible extensions 44, it may be desirable to cover the extensions. Hollow tube 56 may be positioned to extend over flexible extensions 44 and rest on tray 36. When ring 42 is used, tube 56 covers the ring also. Tube 56 does not interfere with the tilting action of tray 36 as it is not attached. See FIG. 10. The tube merely covers the flexible extensions to prevent these being engaged by a squirrel.

The cone-shaped washer may be formed with two flat sides. In this arrangement, the larger flat side would be connected in fixed position with the tray and the smaller flat side positioned in engagement with the flat washer. The opening through the cone-shaped washer would be enlarged so that a tilting action would occur between the cone-shaped washer and the flat washer when a weight engages the tray. The degree of tilt is determined by the size of the opening through the flat washer and tray.

The degree of tilt may also be adjusted when using the cone-shaped and flat washer by inserting collar 66 over the extension pole, increasing its diameter, and, thereby, reducing the open space between the extension pole and the opening in the tray. See FIG. 7. It may be desirable to provide a weight atop tray 36 and about extension 64 stabilize the tray.

While a preferred embodiment of the invention has been described using specific terms, such description is for illustrative purposes only, and it is to be understood that changes and variations may be made without departing from the spirit or scope of the following claims.

What is claimed is:

1. A bird feeder for storing and dispensing bird seed including a squirrel guard:
said feeder comprising an upstanding housing formed along a vertical axis including side walls, a roof and a floor adjacent its lower side;
a support for positioning said feeder in an elevated position;
said squirrel guard comprising a round planar tray having a generally circular opening about its axis, said tray being mounted beneath said lower side to prevent squirrel access to said bird seed and as a collection tray for spilled bird seed;
a connector beneath said lower side engaged with and maintaining said tray in a generally horizontal collecting position perpendicular to said vertical axis when only a minimal weight is carried by said tray and allowing said tray to tilt to a discharge position generally diagonal of said vertical axis when engaged with a relatively heavy weight; wherein,
said tray normally remains in said collecting position collecting spilled bird seed but is moved to said discharge position when engaged by a squirrel causing said squirrel to fall from said tray and away from said bird feeder.

2. The arrangement according to claim 1 wherein said connector comprises a rod with an extension extending through said opening;
a flat washer and a cone-shaped washer secured with said extension in spaced position beneath said lower side, said flat washer engaging an underside of said tray supporting said tray in said generally horizontal position while said cone-shaped washer engages an inner edge of said opening maintaining said tray centered about said vertical axis, said cone-shaped washer allowing said tray to pivot to said discharge position when engaged by said squirrel and guides said tray to said centered and horizontal position upon departure of said squirrel.

3. The arrangement of claim 1 wherein said support comprises a pole secured at a lower end with the ground to extend vertically, an extension formed at an upper end of said pole, said extension supporting said cone-shaped washer over said flat washer forming said connector.

4. The arrangement of claim 3 wherein said flat washer supports said tray in a generally horizontal position and said cone-shaped washer acts to center said tray about said vertical axis and allows said tray to tilt.

5. The arrangement according to claim 2 wherein said opening is about 1 3/16″ in diameter; said flat washer is 1¾″ in diameter; and, said cone-shaped washer is about 1 5/16″ in diameter.

6. The arrangement of claim 1 wherein said connector comprises a plurality of flexible extensions extending parallel of said vertical axis beneath said lower side, said extensions being engaged with said tray generally adjacent and about said circular opening.

7. The arrangement of claim 6 wherein said flexible extensions are engaged with said lower side.

8. The arrangement of claim 6 wherein said flexible extensions are engaged with a ring located beneath said lower side.

9. The arrangement according to claim 8 wherein said support comprises a rod secured at one end with the ground in a vertical position and having at a second end an extension and a shoulder, said extension and shoulder supporting said ring.

10. The arrangement according to claim 6 including a flexible extension guard comprising an elongated hollow member which encases said flexible extensions and is supported on an upper side of said tray, said guard being capable of unidirectional movement to allow said tray to tilt to said discharge position.

11. The arrangement of claim 1 wherein said connector comprises a pole pivotally secured with at least one of said lower side and said tray along said axis, said pivotal engagement allowing said tray to move between said discharge position and said horizontal position.

12. The arrangement of claim 11 wherein said pole is connected at its upper end with said lower side and with a flat and cone-shaped washer at its lower end.

13. The arrangement of claim 2 wherein said support includes a C-shaped rod engaged at one end with said extension to extend along a generally vertical plane and at an opposite end with said roof; whereby,
said feeder is held in said elevated position above said tray.

14. The arrangement according to claim 3 including an extension pole supported at one end over said extension and engaged with an opposite end with said bird feeder.

15. The arrangement according to claim 14 wherein said extension pole is secured in fixed position with said lower side.

16. The arrangement according to claim 1 wherein said tray includes spaced turned edges extending perpendicular of said planar surface, said turned edges may extend in an upwardly or downwardly direction when said tray is in position.
